(19) United States
(12) Patent Application Publication
(10) Pub. No.: US 2022/0321685 A1
(43) Pub. Date: Oct. 6, 2022

(54) ELASTIC DRIVING BODY

(71) Applicant: AUFLEX CO., LTD., Hwaseong-si (KR)

(72) Inventors: Hyun Min PARK, Suwon-si (KR); Yoon Je WOO, Siheung-si (KR)

(21) Appl. No.: 17/615,645

(22) PCT Filed: Jun. 3, 2020
(86) PCT No.: PCT/KR2020/007237

§ 371 Date: Dec. 1, 2021

(30) Foreign Application Priority Data
Jun. 3, 2019 (KR) 10-2019-0065487
Jul. 14, 2019 (KR) 10-2019-0084835

(51) Int. Cl. H04M 1/02; F16C 11/04

(52) U.S. Cl. CPC H04M 1/0216; F16C 11/04

(57) ABSTRACT

An elastic driving body is provided in a foldable display device in which a foldable flexible display panel is provided and which is foldable at a central portion in which two panel units are connected to each other. The elastic driving body applies an elastic force to the panel units while the panel units are being folded or unfolded.

### BACKGROUND

### Field of the Invention

The invention relates to an elastic driving body and more particularly to an elastic driving body that is provided in a central portion in which two panel units are connected in a foldable display device with a foldable flexible display panel such that the two panel units are folded or unfolded in a semiautomatic manner and that allows the foldable display device to be folded or unfolded without using a drive device such as a motor.

### Description of Related Art

Mobile communication terminals are configured to perform various functions. Examples of the functions include a data and speech communication function, a function of capturing a still image or a moving image using a camera, a speech storing function, a function of reproducing a music file using a speaker system, and a function of displaying a still image or a moving image (a video).

Some mobile communication terminals have additional functions for playing games, and some mobile communication terminals are embodied as multimedia devices. Recent mobile communication terminals can also receive broadcast or multicast signals and reproduce a video or a television program.

Researches for supporting and improving other functions of mobile communication terminals in addition to the above-mentioned functions have been carried out. These researches include modification and improvement of structural constituents of the mobile communication terminals and addition and improvement of software or hardware.

In general, a display module of a mobile communication terminal displays information which is processed by the mobile communication terminal. For example, when the mobile communication terminal is in a call mode, the display module displays a user interface (UI) or a graphic user interface (GUI) associated with a call.

When the mobile communication terminal is in a video call mode or an image capturing mode, the display module displays a captured or/and received image, a UI, or a GUI. The display module includes a liquid crystal display, a thin-film transistor liquid crystal display, an organic light emitting diode, a flexible display, or a 3D display.

A flexible display (or a flexible LCD) has been regularly researched with its merit of deformability. It takes much time to use a rolled display like a paper roll as shown in science-fiction movies.

Therefore, transitional forms of flexible displays will be many used until the flexible displays are regularly used with sufficient development thereof, and these transitional forms will be similar to current structures of communication terminals. Accordingly, there is necessity for description of usage and protection of flexible displays when such flexible displays are used in mobile communication terminals.

An example of such an elastic driving body is disclosed in Korean Patent No. 10-0949839 (Title of the Invention: PORTABLE DEVICE FOR MOBILE TERMINAL).

Another example of such an elastic driving body is disclosed in Korean Patent Application Laid-open No. 10-2018-0010019 (published Jan. 30, 2018, Title of the Invention: FOLDABLE DISPLAY DEVICE).

### SUMMARY

An objective of the invention is to provide an elastic driving body that is provided in a central portion in which two panel units are connected in a foldable display device with a foldable flexible display panel such that the two panel units are folded or unfolded in a semiautomatic manner and that allows the foldable display device to be folded or unfolded without using a drive device such as a motor.

In order to achieve the above-mentioned objective, there is provided an elastic driving body including a body, a spring subassembly, and a slide.

The spring subassembly is installed in each of attachment portions provided on right and left sides of the body. The slide slides vertically in the body. The spring subassembly includes a spring head, a coil spring, and a spring case which are coupled.

The spring subassembly is rotatable in a state in which the bottom surface of the spring case is attached to the corresponding attachment portion.

The spring heads of the spring subassemblies are attached to attachment portions of the slide such that the spring heads are rotatable.

A rail section is formed to be open in a rear surface of each of two tilt links on the right and left sides, and a protruding boss of the slide is inserted into the rail section such that the boss is movable.

A protruding and extending rail may be formed on the bottom surface of the slide, and the rail may slide along a rail guide which is formed as an extending groove in the body.

The slide may receive an elastic force from the spring subassembly when the slide moves in the body.

A sub-link may be provided between the two tilt links, and the two tilt links may rotate along a rounded groove of the sub-link in a state in which the sub-link is interposed between the two tilt links.

A portion to which an elastic force of the spring subassembly is applied in a direction perpendicular to a direction in which the slide moves may serve as a critical point receiving a force such that the slide does not move vertically in the body.

The elastic driving body according to the invention is provided in a foldable portion of a foldable display device in which two panel units are folded. When a user intends to fold the panel units of the foldable display device, the two penal units are automatically completely folded after the panel units are folded about a half. When the user intends to unfold the folded panel units, the panel units are automatically fully unfolded after the panel units are unfolded about a half. Accordingly, it is possible to fold or unfold the foldable display device in a semiautomatic manner without using a motor or the like.

With the elastic driving body according to the invention, it is possible to smoothly fold and unfold the foldable display device. Accordingly, a user of the foldable display device which is used as a mobile terminal such as a smartphone can feel a sense of high grade from the product.

### BRIEF DESCRIPTION OF DRAWINGS

FIG. 1 is an exploded perspective view of a body of an elastic driving body and a spring subassembly according to the invention.

FIG. 2 is a perspective view illustrating a state in which a slide is installed in the spring subassembly provided in the body in FIG. 1.

FIG. 3 is a diagram illustrating movement of the spring subassembly when the slide moves vertically in the body of the elastic driving body according to the invention.

FIG. 4 is a perspective view illustrating a state in which two tilt links and a sub-link are being assembled into the body in a state in which slide has been assembled into the body in FIG. 2.

FIG. 5 is a perspective view illustrating a state in which a cover is being installed on one side surface in a state in which the two tilt links and the sub-link have been assembled in the body according to the invention in FIG. 4.

FIG. 6 is a perspective view illustrating a state in which the elastic driving body according to the invention has been completely assembled.

FIG. 7 is a perspective view illustrating a state in which the two tilt links in the elastic driving body according to the invention are partially folded.

FIG. 8 is a perspective view illustrating a state in which the two tilt links in the elastic driving body according to the invention have been completely folded.

FIG. 9 is a perspective top view illustrating movement of the elastic driving body according to the invention.

FIG. 10 is a perspective bottom view illustrating movement of the elastic driving body according to the invention.

FIG. 11 is a perspective view illustrating a state in which the elastic driving body according to the invention is installed in a hinge unit located in a foldable portion of a foldable display device.

FIG. 12 is a perspective view illustrating a state in which the elastic driving body according to the invention is assembled into a foldable display device.

FIG. 13 is a perspective view illustrating a state in which panel units are fully unfolded in a state in which the elastic driving body according to the invention has been installed in the foldable display device.

FIG. 14 is a perspective view illustrating a state in which the panel units are partially folded in a state in which the elastic driving body according to the invention has been installed in the foldable display device.

FIG. 15 is a perspective view illustrating a state in which the panel units are completely folded in a state in which the elastic driving body according to the invention has been installed in the foldable display device.

** REFERENCE SIGNS LIST **

| | |
|---|---|
| 10: BODY | 20: SPRING SUBASSEMBLY |
| 12: ATTACHMENT PORTION | 30: SLIDE |
| 36: BOSS | 40: TILT LINK |
| 42: RAIL SECTION | 50: SUB-LINK |

### EMBODIMENTS OF THE INVENTION

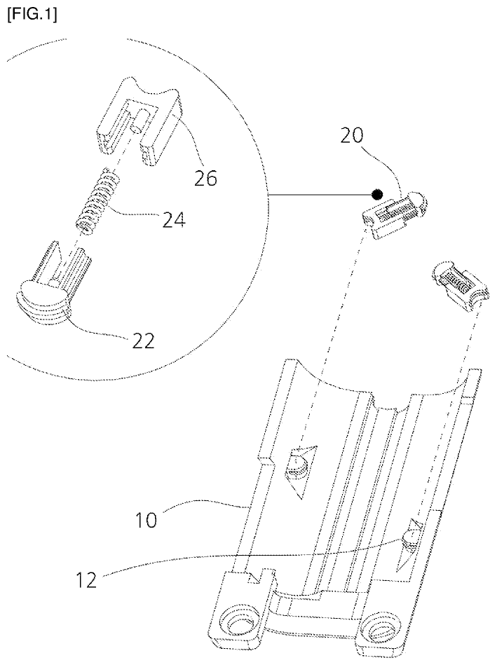

FIG. 1 is an exploded perspective view of a body of an elastic driving body and a spring subassembly according to the invention.

Referring to FIG. 1, a spring subassembly 20 is provided in each of attachment portions 12 which are provided in right and left sides of a body 10 of an elastic driving body according to the invention. The spring subassembly 20 includes a spring head 22, a coil spring 24, and a spring case 26.

A bottom surface of the spring case 26 of the spring subassembly 20 is attached to the attachment portion 12, and the spring subassembly 20 can rotate in this state.

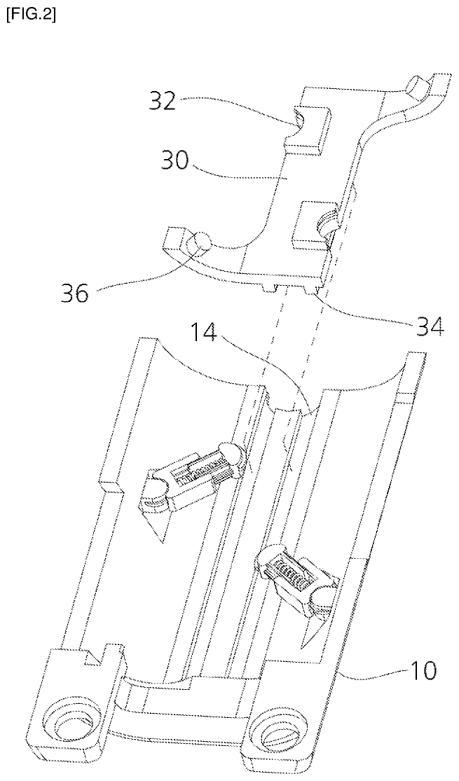

FIG. 2 is a perspective view illustrating a state in which a slide is installed in the spring subassembly provided in the body in FIG. 1.

Referring to FIG. 2, a slide 30 that slides vertically in the body 10 is installed in the body 10 such that the spring head 22 of the spring subassembly 20 is placed in an attachment portion 32 of the slide 30 and is rotatable in this state.

A protruding and extending rail 34 is formed on the bottom surface of the slide 30. The rail slides along a rail guide 14 which is formed as an extending groove in the body 10.

When the slide 30 moves on the body 10, the slide 30 receives an elastic force from the spring subassembly 20.

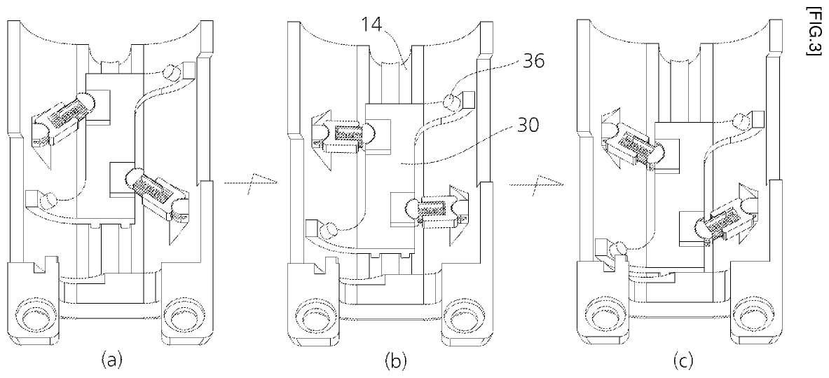

FIG. 3 is a diagram illustrating movement of the spring subassembly when the slide moves vertically in the body of the elastic driving body according to the invention.

Referring to FIG. 3, when the slide 30 slides downward with an external force from a user and reaches a middle position of the body 10 (b) in a state in which the slide 30 is located at an upper position of the body 10, the slide 30 stops. When the slide 30 is additionally pressed downward over the middle position (b) with the external force from the user, the slide 20 moves automatically to a lower position of the body 10.

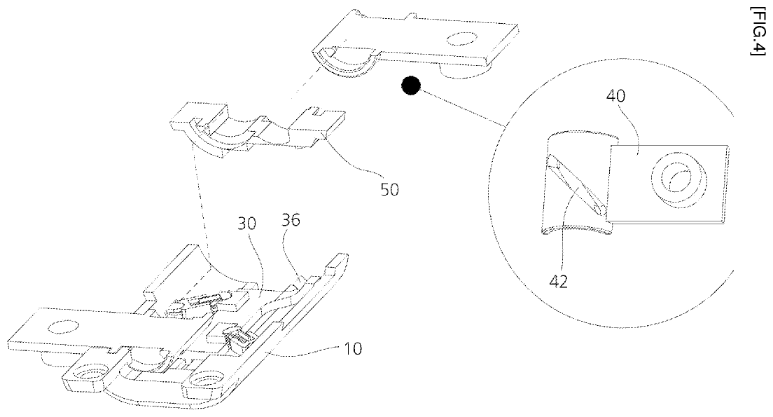

FIG. 4 is a perspective view illustrating a state in which two tilt links and a sub-link are being assembled into the body in a state in which slide has been assembled into the body in FIG. 2.

Referring to FIG. 4, a rail section 42 is formed to be open in the rear surface of each of two tilt links 40 on the right and left sides. Protruding bosses 36 of the slide 30 are inserted into the rail sections 42 such that the slide is movable.

A sub-link 50 is provided between the two tilt links 40. The tilt links 40 rotate along a rounded groove of the sub-link 50 in a state in which the sub-link 50 is interposed between the two tilt links 40.

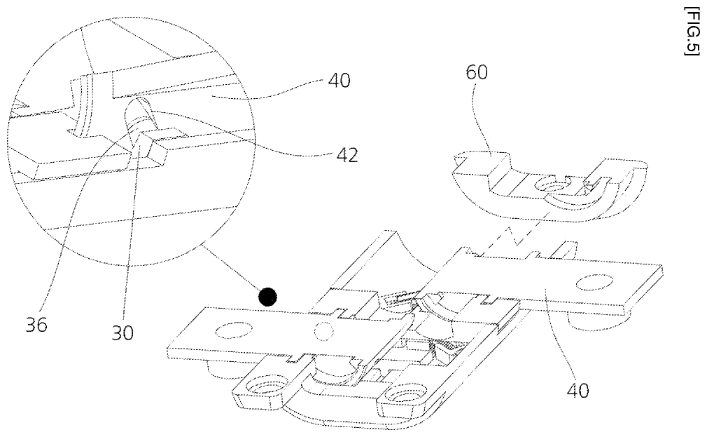

FIG. 5 is a perspective view illustrating a state in which a cover is being installed on one side surface in a state in which the two tilt links and the sub-link have been assembled in the body according to the invention in FIG. 4.

Referring to FIG. 5, a cover 60 is assembled on one end face of the body 10 in a state in which two tilt links 40 and one sub-link 50 have been assembled into the body 10, whereby assembling of the elastic driving body according to the invention is completed.

When the tilt links 40 are assembled onto the slide 30 placed on the body 10, the protruding bosses 36 of the slide 30 are inserted into the rail sections 42 of the tilt links 40.

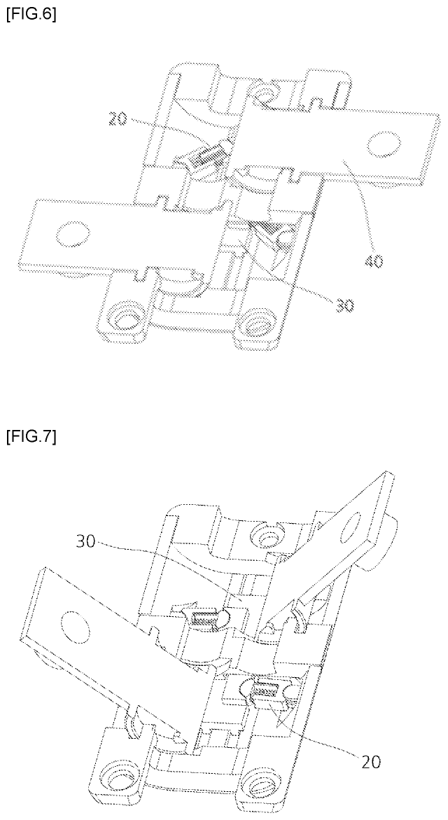

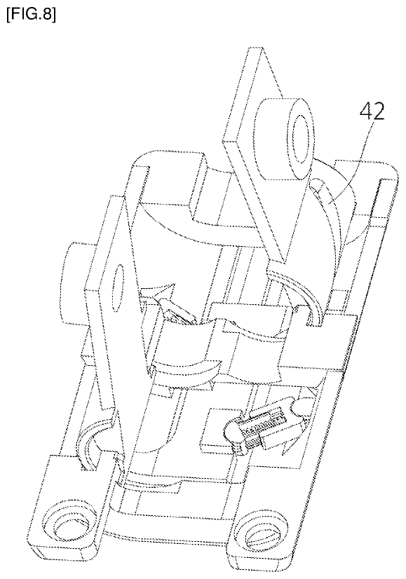

FIG. 6 is a perspective view illustrating a state in which the elastic driving body according to the invention has been completely assembled. FIG. 7 is a perspective view illustrating a state in which the two tilt links in the elastic driving body according to the invention are partially folded. FIG. 8 is a perspective view illustrating a state in which the two tilt links in the elastic driving body according to the invention have been completely folded.

Referring to FIGS. 6 to 8, an elastic force of the spring subassembly 20 is applied in a direction perpendicular to the direction in which the slide 30 moves in FIG. 7 while a pair of tilt links 40 are being folded. The pair of tilt links 40 are folded or unfolded in a semiautomatic manner with respect to a critical point receiving a force such that the slide 30 does not move vertically in the body 10.

As can be seen from FIGS. 6 and 8, the spring subassemblies 20 are folded in different directions. This is because directions in which the spring subassemblies 20 apply a force to the slide 30 with movement of the slide 30 along the body 10 are changed.

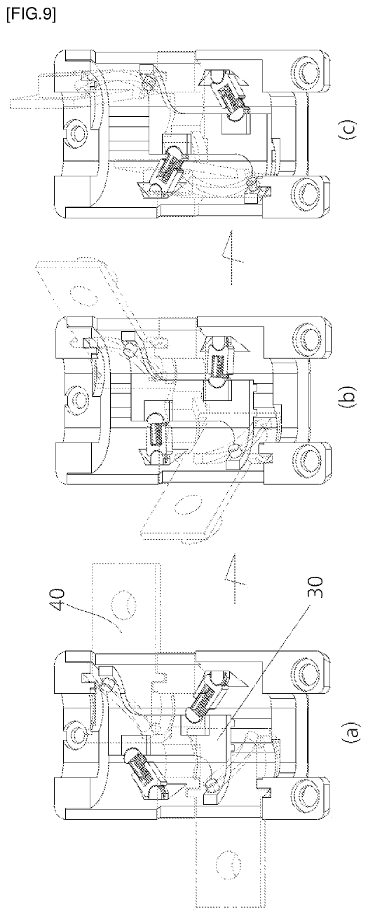

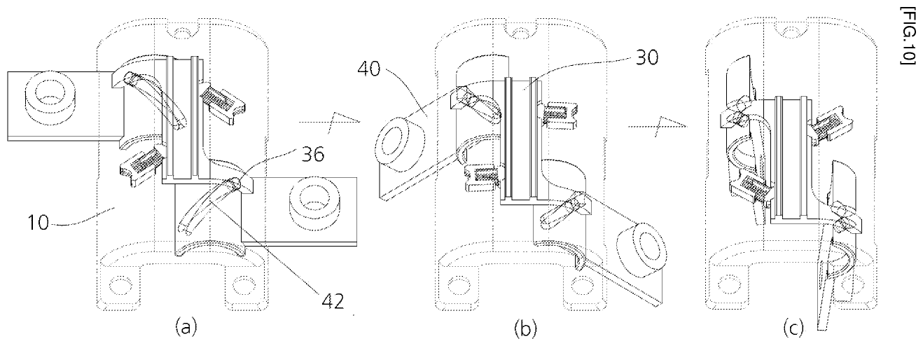

FIG. 9 is a perspective top view illustrating movement of the elastic driving body according to the invention. FIG. 10 is a perspective bottom view illustrating movement of the elastic driving body according to the invention.

The principle in which the elastic driving body according to the invention operates will be described below with reference to FIGS. 9 and 10. When a pair of tilt links 40 is folded, the bosses 36 of the slide 30 inserted into the rail sections 42 in the rear surfaces of the tilt links 40 move along the rail sections 42 and the slide 30 moves in the body 10 therewith.

The slide 30 continuously receives an elastic force from the spring subassemblies 20.

Accordingly, when the slide 20 reaches the state illustrated in (b) of FIGS. 9 and 10, an elastic force from the spring subassemblies 20 is applied in the direction perpendicular to the direction in which the slide 30 moves and thus the portion to which the elastic force is applied serves as a critical point receiving a force such that the slide 30 does not move vertically in the body 10.

When the slide 30 moves upward or downward from the state illustrated in (b) of FIGS. 9 and 10, the slide 30 receives an elastic force from the spring subassemblies 20 such that the two tilt links 40 are folded or unfolded in a semiautomatic manner.

Since the slide 30 includes two bosses 36 and the bosses 36 are inserted into the rail sections 42 of the corresponding tilt links 40 and move, the two tilt links 40 rotate simultaneously in the opposite directions in synchronization with each other when the tilt links 40 are folded or unfolded.

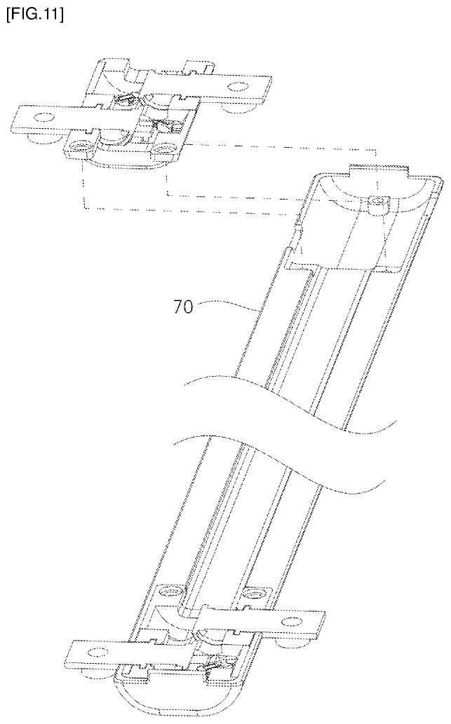

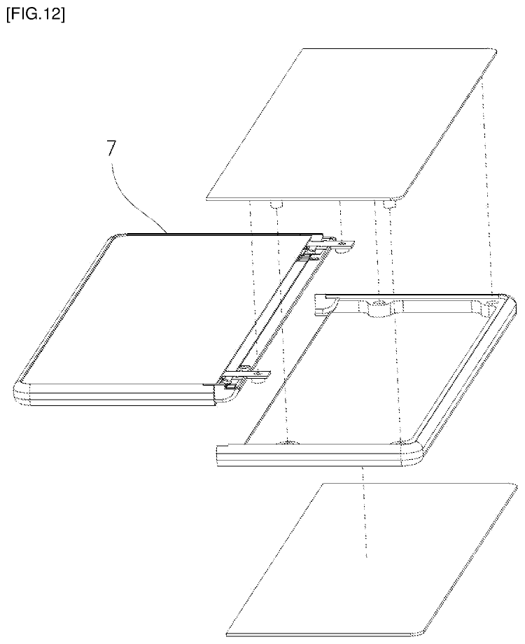

FIG. 11 is a perspective view illustrating a state in which the elastic driving body according to the invention is installed in a hinge unit located in a foldable portion of a foldable display device. FIG. 12 is a perspective view illustrating a state in which the elastic driving body according to the invention is assembled into a foldable display device.

Referring to FIGS. 11 and 12, the elastic driving body is disposed vertically in a hinge unit 70 which is provided in a foldable portion of the foldable display device. Panel units 7 are provided on right and left sides of the hinge unit 70, and a flexible display panel on which information such as a still image or a moving image is displayed is provided on the panel units 7.

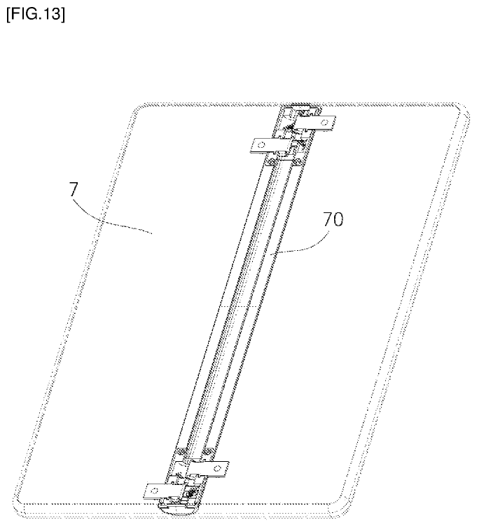

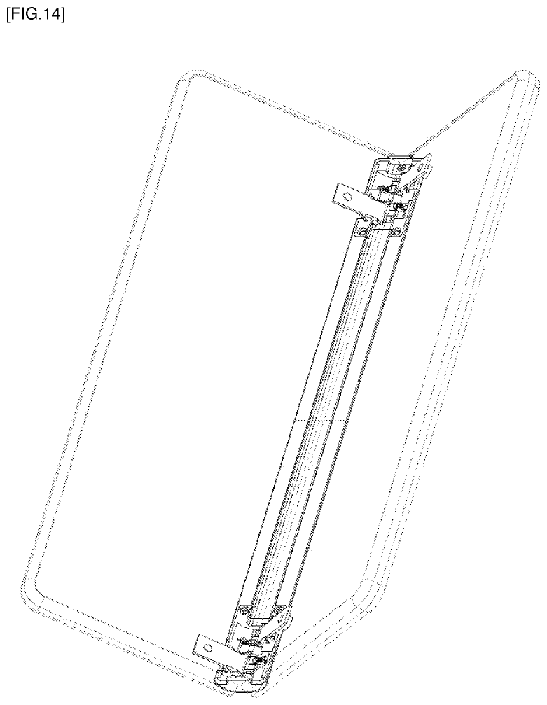

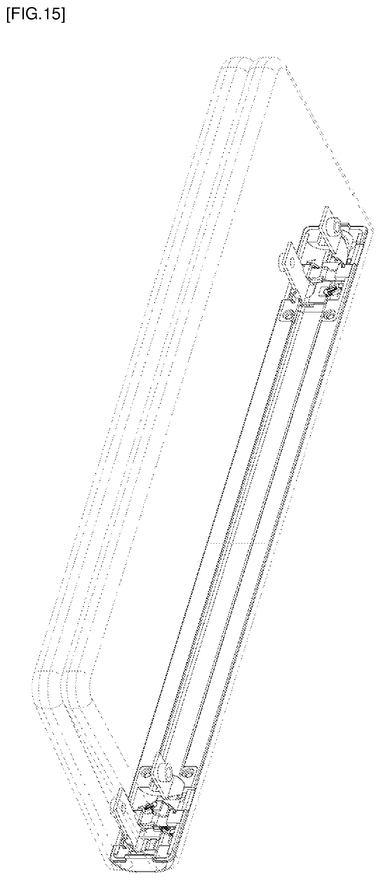

FIG. 13 is a perspective view illustrating a state in which panel units are fully unfolded in a state in which the elastic driving body according to the invention has been installed in the foldable display device. FIG. 14 is a perspective view illustrating a state in which the panel units are partially folded in a state in which the elastic driving body according to the invention has been installed in the foldable display device. FIG. 15 is a perspective view illustrating a state in which the panel units are completely folded in a state in which the elastic driving body according to the invention has been installed in the foldable display device.

Referring to FIGS. 13 to 15, when a user is going to fold the panel units 7 while using the foldable display device with the elastic driving body according to the invention which is used as a product such as a smartphone or a table PC, the two tilt links 40 illustrated in FIG. 4 and fixed to the corresponding panel units 7 simultaneously start folding thereof. As illustrated in FIG. 15, the panel units 7 are automatically folded with the elastic force from the spring subassemblies 20 after the spring subassemblies 20 exceed the critical points illustrated in FIG. 14.

When a user is going to unfold the panel units 7 while using the foldable display device with the elastic driving body according to the invention, the two tilt links 40 illustrated in FIG. 4 simultaneously start unfolding thereof with unfolding of the panel units 7. The panel units 7 are automatically unfolded with the elastic force from the spring subassemblies 20 after the spring subassemblies 20 exceed the critical points, and reach the fully unfolded state illustrated in FIG. 13.

While an exemplary embodiment of the invention has been described above using specific terms, such description is only for explanation and it is obvious that the exemplary embodiment can be modified in various forms without departing from the technical spirit and scope of the appended claims. Such modified embodiments should not be understood separately from the spirit and scope of the invention and should belong to the appended claims.

1. An elastic driving body comprising:
a body;
a spring subassembly that is installed in each of attachment portions provided on right and left sides of the body; and
a slide that slides vertically in the body,
wherein the spring subassembly includes a spring head, a coil spring, and a spring case which are coupled,
wherein the spring subassembly is rotatable in a state in which the bottom surface of the spring case is attached to the corresponding attachment portion,
wherein the spring heads of the spring subassemblies are attached to attachment portions of the slide such that the spring heads are rotatable, and
wherein a rail section is formed to be open in a rear surface of each of two tilt links on the right and left sides, and a protruding boss of the slide is inserted into the rail section such that the boss is movable.

2. The elastic driving body according to claim 1, wherein a protruding and extending rail is formed on the bottom surface of the slide, and the rail slides along a rail guide which is formed as an extending groove in the body, and
wherein the slide receives an elastic force from the spring subassembly when the slide moves in the body.

3. The elastic driving body according to claim 1, wherein a sub-link is provided between the two tilt links, and the two tilt links rotate along a rounded groove of the sub-link in a state in which the sub-link is interposed between the two tilt links.

4. The elastic driving body according to claim 1, wherein a portion to which an elastic force of the spring subassembly is applied in a direction perpendicular to a direction in which the slide moves serves as a critical point receiving a force such that the slide does not move vertically in the body.
